(19) United States
(12) Patent Application Publication
(10) Pub. No.: US 2009/0248512 A1
(43) Pub. Date: Oct. 1, 2009

(54) SYSTEM AND METHOD FOR INCORPORATING TARGETED CONTENT IN A DOCUMENT

(76) Inventors: William Su, Riverside, CA (US); Jianxin Wang, Trabuco Canyon, CA (US); Giri Natarajan, La Palma, CA (US); Mohammad A. Suleiman, Trabuco Canyon, CA (US); Ming-Teh Shen, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/060,524

(22) Filed: Apr. 1, 2008

(51) Int. Cl. G06Q 30/00; G06F 3/14; G06Q 20/00; G06Q 10/00

(52) U.S. Cl. 705/14; 715/209; 705/39; 705/400

(57) ABSTRACT

The subject application is directed to a system and method for selective incorporation of targeted content in remotely rendered documents. An electronic document is first received from an owner. Layout data corresponding to the size and/or position available for placement of secondary content in connection with a rendering of the electronic document is then received. Destination data corresponding to an output destination for a rendering of the electronic document is then received. The secondary content is then retrieved in accordance with the received destination data and formatted based upon the received layout data. The electronic document and the secondary content are then communicated to an output destination in accordance with the received destination data so as to generate a rendered document at the output destination, with the rendered document incorporating the electronic document and secondary content mutually arranged based upon the layout data.

### BACKGROUND OF THE INVENTION

The subject application is directed generally to rendering of electronic documents with added content, such as by printing or facsimile transmission. The subject application is particularly applicable to a system and method for fee-based additions of geographically relevant advertising material that is inserted into remotely rendered documents within limits set by a document owner prior to transmission.

Electronic documents are frequently transmitted for remote rendering. Such transmissions suitably occur via facsimile transmission or by a remote printing operation, such as by printing over a wide area network or WAN. Once example of a WAN printing operation is when an electronic document is communicated to a remote printer in a data path that includes the Internet. More recently, remote rendering of electronic documents is being accomplished by use of shared document resources, such as document processing stores or document processing kiosks situated in common areas, such as hotels or airports.

For remote rendering, a document owner loads an electronic document for which transmission is desired into a local device, and enters one or more destinations to which that document is targeted. In the case of a facsimile transmission, a user may simply enter the phone number of a desired facsimile machine. In a case of a remote print operation, an owner suitably enters information as to each printer from which a remote rendering is desired. In a typical operation, the document owner assumes costs associated with transmitting the document to each desired location. In such operations, each recipient receives a similar output, irrespective of where each recipient is located, and the owner pays the fees associated with each transmission.

### SUMMARY OF THE INVENTION

In accordance with one embodiment of the subject application, there is provided a system and method for rendering of electronic documents with added content, such as by printing or facsimile transmission.

Further, in accordance with one embodiment of the subject application, there is provided a system and method for fee-based additions of geographically relevant advertising material that is inserted into remotely rendered documents within limits set by a document owner prior to transmission.

Still further, in accordance with one embodiment of the subject application, there is provided a system for selective incorporation of targeted content in remotely rendered documents. The system includes means adapted for receiving an electronic document from an owner thereof and means adapted for receiving layout data corresponding to at least one of a size and position available for placement of secondary content in connection with a rendering of the electronic document. The system further includes means adapted for receiving destination data corresponding to at least one output destination for a rendering of the electronic document, retrieval means adapted for retrieving secondary content in accordance with received destination data, and means adapted for formatting retrieved secondary content in accordance with received layout data. The system also comprises means adapted for communicating the received electronic document and retrieved secondary content to at least one output destination in accordance with received destination data so as to generate a rendered document at the at least one output destination, wherein the rendered document includes the received electronic document and retrieved secondary content mutually arranged in accordance with the layout data.

In one embodiment of the subject application, the system also includes fee calculation means adapted for calculating a fee corresponding to rendered secondary content and means adapted for crediting a fee calculated by the fee calculation means to the owner.

In another embodiment of the subject application, the fee calculation means further includes means adapted for calculating the fee in accordance with received layout data.

In a further embodiment of the subject application, the secondary content includes data corresponding to an advertisement for at least one of goods or services available at the at least one output destination.

In yet another embodiment of the subject application, system also comprises analyzing means adapted for analyzing content of the electronic document. In such embodiment, the retrieval means further includes means adapted for retrieving secondary content in accordance with an analysis of content by the analyzing means.

Still further, in accordance with one embodiment of the subject application, there is provided a method for selective incorporation of targeted content in remotely rendered documents in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for selective incorporation of targeted content in remotely rendered documents according to one embodiment of the subject application;

FIG. 2 is a block diagram illustrating controller hardware for use in the system for selective incorporation of targeted content in remotely rendered documents according to one embodiment of the subject application;

FIG. 3 is a functional diagram illustrating the controller for use in the system for selective incorporation of targeted content in remotely rendered documents according to one embodiment of the subject application;

FIG. 4 is a diagram illustrating a server for use in the system for selective incorporation of targeted content in remotely rendered documents according to one embodiment of the subject application;

FIG. 5 is a flowchart illustrating a method for selective incorporation of targeted content in remotely rendered documents according to one embodiment of the subject application; and

FIG. 6 is a flowchart illustrating a method for selective incorporation of targeted content in remotely rendered documents according to one embodiment of the subject application.

### DETAILED DESCRIPTION OF THE PREFERRED EMBODIMENT

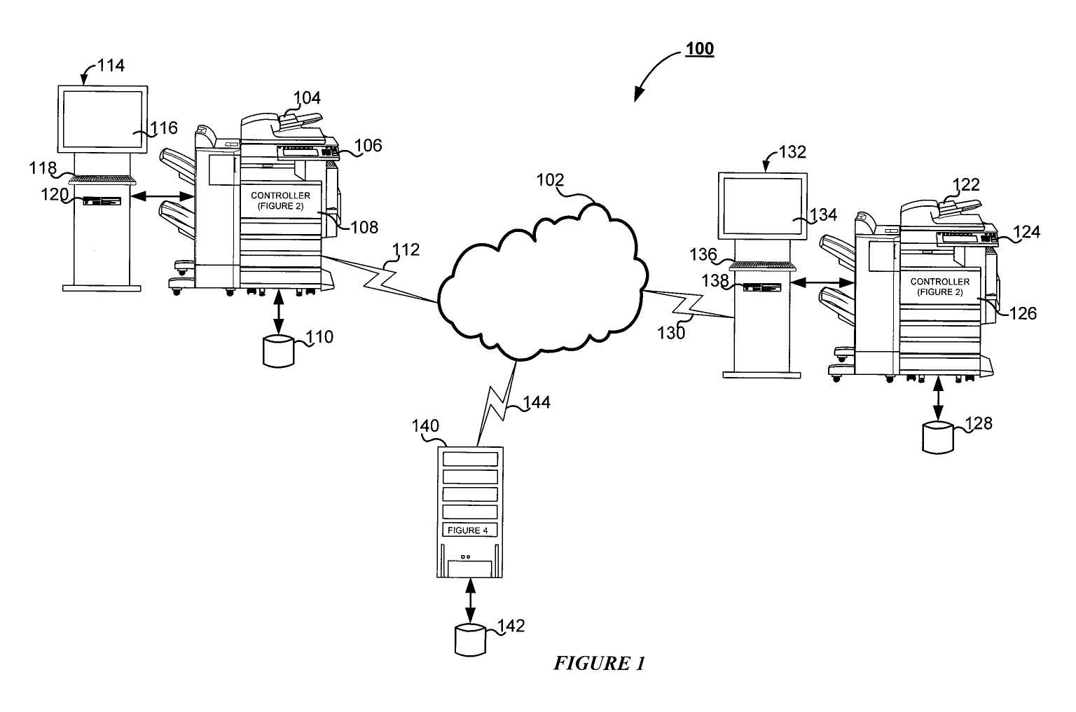

The subject application is directed to a system and method for rendering electronic documents with added content, such as by printing or facsimile transmission. In particular, the subject application is directed to a system and method for fee-based additions of geographically relevant advertising material that is inserted into remotely rendered documents within limits set by a document owner prior to document transmission. More particularly, the subject application is directed to a system and method for selective incorporation of targeted content in remotely rendered documents. It will become apparent to those skilled in the art that the system and method described herein are suitably adapted to a plurality of varying electronic fields employing fee-based transactions, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for selective incorporation of targeted content in remotely rendered documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a first document processing device 104 and a second document processing device 122, which are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104 and 122 are suitably adapted to provide remote document processing services to external or network devices. Preferably, the document processing devices 104 and 122 include hardware, software, and any suitable combination thereof, configured to interact with an associated user, a networked device, or the like.

According to one embodiment of the subject application, the document processing devices 104 and 122 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104 and 122 further include associated user interfaces 106 and 124, such as touch-screens, LCD displays, touch-panels, alpha-numeric keypads, or the like, via which an associated user is able to interact directly with the respective document processing device 104 or 122. In accordance with the preferred embodiment of the subject application, the user interfaces 106 and 124 are advantageously used to communicate information to the associated user and receive selections from the associated user. The skilled artisan will appreciate that the user interfaces 106 and 124 comprise various components, suitably adapted to present data to the associated user, as are known in the art. In accordance with one embodiment of the subject application, each of the user interfaces 106 and 124 comprises a display, suitably adapted to display one or more graphical elements, text data, images, or the like, to an associated user, receive input from the associated user, and communicate the same to a backend component, such as the controllers 108 and 126, as explained in greater detail below. Preferably, the document processing devices 104 and 122 are communicatively coupled to the computer network 102 via corresponding communications links 112 and 130. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

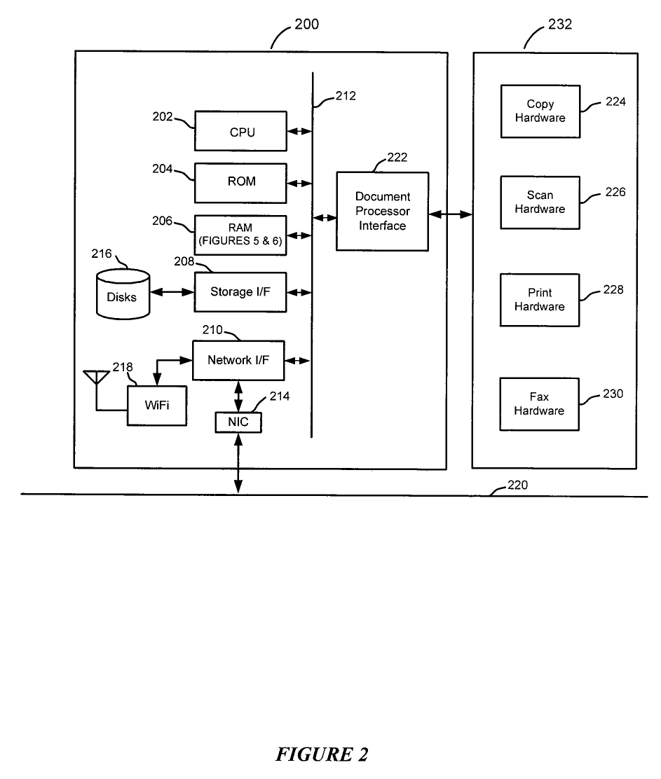

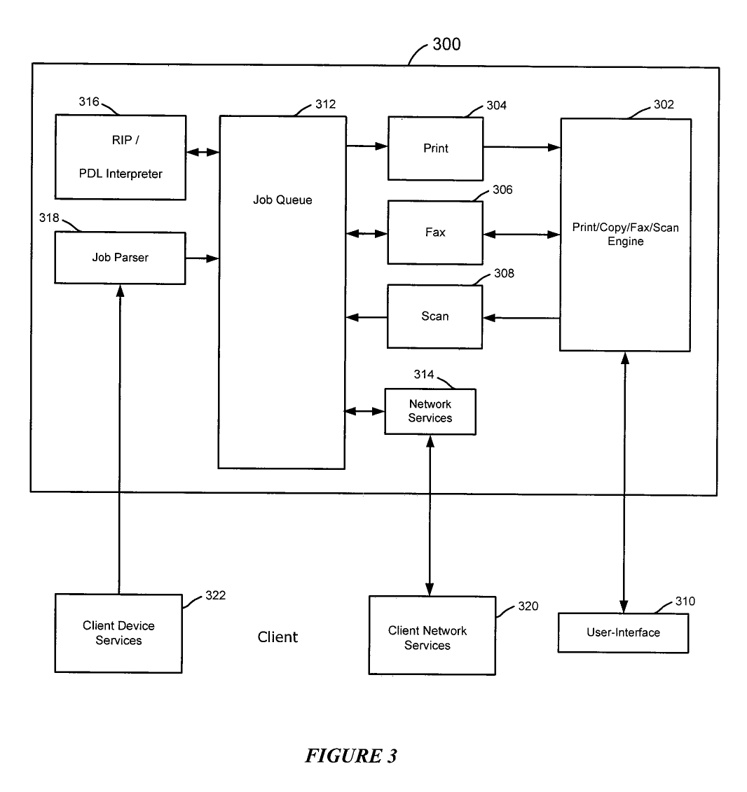

In accordance with one embodiment of the subject application, each of the document processing devices 104 and 122 further incorporates a backend component, designated as the controllers 108 and 126, suitably adapted to facilitate the operations of the corresponding document processing device 104 and 122, as will be understood by those skilled in the art. Preferably, the controllers 108 and 126 are embodied as hardware, software, or any suitable combination thereof, configured to control the operations of the associated document processing device 104 or 122, facilitate the display of images via the user interface 106 or 124, direct the manipulation of electronic image data, and the like. For purposes of explanation, the controllers 108 and 126 are used to refer to any myriad of components associated with the document processing devices 104 and 122, including hardware, software, or combinations thereof, functioning to perform, cause to be performed, control, or otherwise direct the methodologies described hereinafter. It will be understood by those skilled in the art that the methodologies described with respect to the controllers 108 and 126 are capable of being performed by any general purpose computing system, known in the art, and thus the controllers 108 and 126 are representative of such general computing devices and are intended as such when used hereinafter. Furthermore, the use of the controllers 108 and 126 hereinafter is for the example embodiment only, and other embodiments, which will be apparent to one skilled in the art, are capable of employing the system and method for selective incorporation of targeted content in remotely rendered documents of the subject application. The functioning of the controllers 108 and 126 will better be understood in conjunction with the block diagrams illustrated in FIGS. 2 and 3, explained in greater detail below.

Communicatively coupled to the document processing devices 104 and 122 are corresponding data storage devices 110 and 128. In accordance with the preferred embodiment of the subject application, the data storage devices 110 and 128 are any mass storage devices known in the art including, for example and without limitation, magnetic storage drives, a hard disk drive, optical storage devices, flash memory devices, or any suitable combination thereof. In the preferred embodiment, the data storage devices 110 and 128 are suitably adapted to store document data, image data, electronic database data, or the like. It will be appreciated by those skilled in the art that while illustrated in FIG. 1 as being separate components of the system 100, the data storage devices 110 and 128 are capable of being implemented as an internal storage component of the associated document processing device 104 or 122, a component of the controllers 108 or 126, or the like, such as, for example and without limitation, an internal hard disk drive, or the like. In accordance with one embodiment of the subject application, the data storage devices 110 and 128 are capable of storing images, advertisements, user information, location information, output templates, mapping data, multimedia data files, fonts, and the like.

Illustrated in FIG. 1 are a first kiosk 114, communicatively coupled to the first document processing device 104, and in effect, the computer network 102, and a second kiosk 132, communicatively coupled to the second document processing device 122, and in effect, the computer network 102. It will be appreciated by those skilled in the art that the kiosks 114 and 132 are capable of being implemented as separate component of the respective document processing devices 104 and 122, or as integral components thereof. Use of the kiosks 114 and 132 in FIG. 1 are for example purposes only, and the skilled artisan will appreciate that the subject application is capable of implementation without the use of kiosks 114 and 132. In accordance with one embodiment of the subject application, the kiosks 114 and 132 include respective displays 116 and 134 and user input devices 118 and 136. As will be understood by those skilled in the art the kiosks 114 and 132 are capable of implementing a combination user input device/display, such as a touch screen interface. According to one embodiment of the subject application, the kiosks 114 and 132 are suitably adapted to display prompts to an associated user, receive instructions from the associated user, receive payment data, receive selection data from the associated user, and the like. Preferably, the kiosks 114 and 132 include a magnetic card reader, conventional bar code reader, or the like, suitably adapted to receive and read payment data from a credit card, coupon, debit card, or the like.

The system 100 of FIG. 1 also includes portable storage device readers 120 and 138, coupled to the kiosks 114 and 132 and suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 of FIG. 1 also includes a backend component, illustrated as the server 140 and associated data storage device 142, communicatively coupled to the computer network 102 via a communications link 144. It will be appreciated by those skilled in the art that the server 140 comprises hardware, software, and combinations thereof suitably adapted to provide one or more services, web-base applications, storage options, and the like, to networked devices. In accordance with one embodiment of the subject application, the server 140 includes various components, implemented as hardware, software, or a combination thereof, for managing the retention of electronic data, performing searches, storing advertisements, storing account information, storing billing information, retrieval of documents, and the like, which are accessed via the computer network 102. The communications link 144 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components described with respect to the server 140 hereinafter are capable of implementation on any computing device coupled to the computer network 102 and functioning as a backend server.

Communicatively coupled to the server 140 is the data storage device 142. In accordance with the preferred embodiment of the subject application, the data storage device 142 is any mass storage device, or plurality of such devices, known in the art including, for example and without limitation, magnetic storage drives, a hard disk drive, optical storage devices, flash memory devices, or any suitable combination thereof. In the preferred embodiment, the data storage device 142 is suitably adapted to store software updates, update lists, electronic database data, document data, image data, location data, advertisement data, account data, user data, and the like. It will be appreciated by those skilled in the art that while illustrated in FIG. 1 as being a separate component of the system 100, the data storage device 142 is capable of being implemented as internal storage component of the server 140, or the like, such as, for example and without limitation, an internal hard disk drive, or the like.

Turning now to FIG. 2, illustrated is a representative architecture of a suitable backend component, i.e., the controller 200, shown in FIG. 1 as the controllers 108 and 126, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104 and 122, which includes the controller 200 of FIG. 2, (shown in FIG. 1 as the controllers 108 and 126, respectively) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306, or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

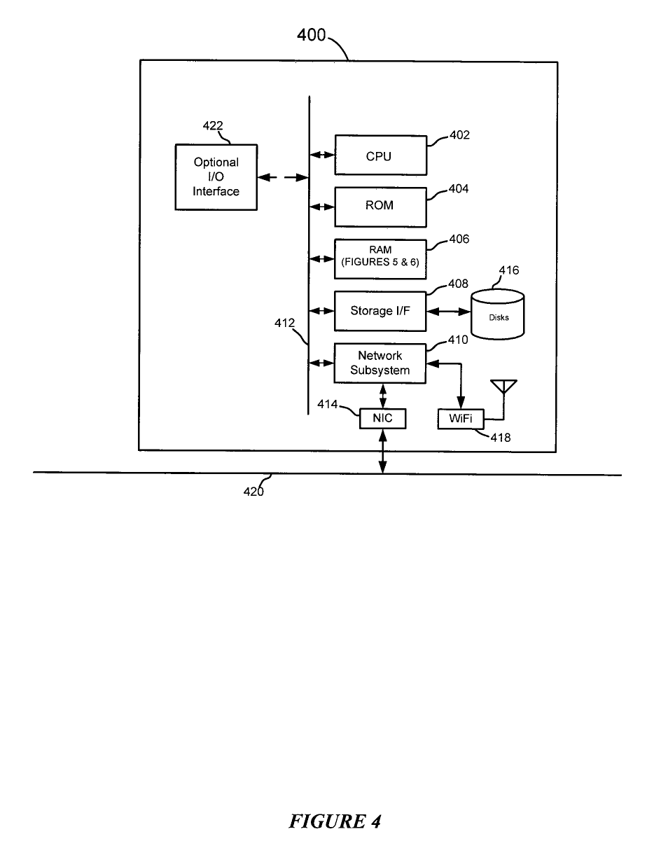

Turning now to FIG. 4, illustrated is a representative architecture of a suitable server 400 (shown in FIG. 1 as the server 140) on which operations of the subject system are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by the processor 402.

A storage interface 408 suitably provides a mechanism for volatile, bulk or long term storage of data associated with the server 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the server 400 to communicate to other devices. The network interface subsystem 410 suitably interfaces with one or more connections with external devices to the server 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Suitable executable instructions on the server 400 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 422 as will be appreciated by one of ordinary skill in the art.

In operation, an electronic document is first received from an owner thereof. Layout data corresponding to the size and/or position available for placement of secondary content in connection with a rendering of the electronic document is then received. Destination data corresponding to an output destination for a rendering of the electronic document is then received. The secondary content is then retrieved in accordance with the received destination data. The retrieved secondary content is then formatted based upon the received layout data. The received electronic document and the retrieved secondary content is then communicated to at least one output destination in accordance with the received destination data so as to generate a rendered document at the output destination. Preferably, the rendered document includes the received electronic document and retrieved secondary content mutually arranged in accordance with the layout data.

According to one example embodiment of the subject application, an electronic document, such as a word-processing document, a scan of a hard copy, a photograph, a map, a web-page, or the like, is first received from an owner. It will be appreciated by those skilled in the art that the owner is capable of communicating the electronic document to a document processing device 104 or 122 via the kiosk 114 or 132, via an electronic mail communication, uploaded to a shared network resource (not shown), stored on the server 140, generated via an operation of the document processing device 104 or 122 or the like. For purposes of example only, reference is made hereinafter to an owner accessing the first document processing device 104 via the kiosk 114 or associated user interface 106 for communication of the electronic document to a remote location, e.g. the second document processing device 122. The skilled artisan will appreciate that while illustrated in FIG. 1 as multifunction peripheral devices, the document processing devices 104 and 122 are capable of being implemented as facsimile machines, networked printers, or any of a myriad of other document processing devices, as are known in the art.

When the electronic document is received by the first document processing device 104, the owner is prompted to specify the layout of a rendered document inclusive of the electronic document. That is, the user provides the controller 108 or other suitable component associated with the document processing device 104 with a pre-determined position on a rendered document of secondary content, i.e. content not included in the original electronic document. According to one embodiment of the subject application, the secondary content includes, for example and without limitation, a preselected advertisement, an automatically generated advertisement, an image, a text box, or the like. In accordance with another embodiment of the subject application, the placement and the shape of the secondary content is capable of being arbitrarily determined by the controller 108 or other suitable component associated with the document processing device 104, selected by the owner, set by the document processing device 104 service provider, or the like.

The controller 108 or other suitable component associated with the first document processing device 104 then receives rendering output destination data from the owner of the document. It will be appreciated by those skilled in the art that the destination data corresponds to the device that the owner selects to output the rendered document, e.g. the second document processing device 122. According to one embodiment of the subject application, the owner inputs the destination data via the user interface 106 or the kiosk 114. In accordance with a further embodiment, the owner communicates with the server 140 via the user interface 106 or kiosk 114 to retrieve recipient information corresponding to a desired destination.

Once the electronic document, secondary content layout data, and destination data have been received, the controller 108 or other suitable component associated with the document processing device 104 determines whether owner specified content has been selected for incorporation as the secondary content data. Stated another way, the controller 108 determines whether or not the owner has specifically identified secondary content, such as an advertisement, map, or the like, for incorporation in the rendered document. When such a determination indicates that owner specified content is available, the secondary content is suitably retrieved, e.g. from the database 142 of the server 140, from a web site, from a portable storage medium, from a second document scanned by the owner, or the like.

When no owner specified content is available, the electronic document is analyzed so as to determine appropriate secondary content. For example, when the electronic document analysis indicates that the electronic document repeatedly references a particular product, an advertisement of a distributor or retailer of that product is retrieved from the database or following an Internet search conducted by the controller 108 or other suitable component associated with the document processing device 104. Thus, once the appropriate secondary content has been identified, it is retrieved by the controller 108 or other suitable component associated with the document processing device 104.

After retrieval of the secondary content, the controller 108 determines whether or not to filter the results so as to limit the secondary content based upon the destination of the rendered document. When it is determined that the secondary content is destination specific, the retrieved secondary content is filtered geographically with respect to the destination. Continuing with the example from above, when filtering is desired, the returned search results of the distributor or retailer of the product is filtered to those distributors or retailers located within a predetermined proximity to the physical location of the destination. Following such filtering, or upon a determination that no filtering is desired, the secondary content data is formatted by the first document processing device 104, or a suitable component thereof, based upon the received layout data. Thereafter, the electronic document and the formatted secondary content are communicated, via the computer network 102, in accordance with the destination data, e.g. the electronic document and the secondary content are communicated to the second document processing device 122 via the computer network 102.

The destination, e.g. the second document processing device 122, then generates a rendered document inclusive of the electronic document and the secondary content data based upon the retrieved layout data. Thus, the second document processing device 122 generates a hard copy document of the electronic document with the secondary content incorporated therein according to the position and shape designated by the layout data. The controller 108 or other suitable component associated with the document processing device 104 then calculates a fee corresponding to the rendered secondary content and credits the calculated fee to the owner. That is, a fee is determined for placement of the secondary content on the rendered document and the amount of that fee is credited to the owner. For example, when the secondary content corresponds to an advertisement supplied by a third party, the owner of the document is credited a predetermined amount of the fee paid by the third party to include the advertisement on the rendered document.

It will be appreciated by those skilled in the art that the first document processing device 104 is capable of communicating the transaction data, the data corresponding to the electronic document and secondary content, to the server 140, whereupon the server 140 determines the appropriate fee to credit and stores such data in an account on the database 142 associated with the owner. According to a further embodiment of the subject application, the owner is charged for the transmission of the electronic document to the destination, with a portion of the costs of the transmission offset due to the inclusion of an advertisement.

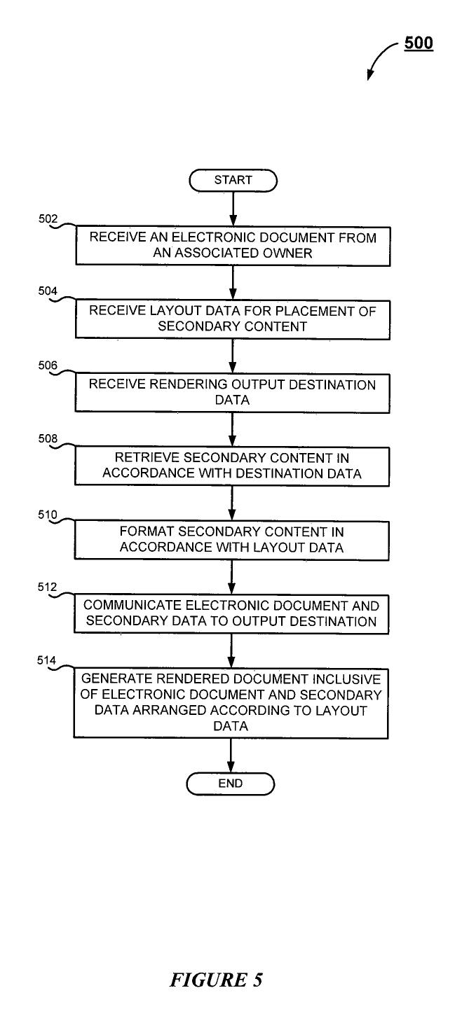

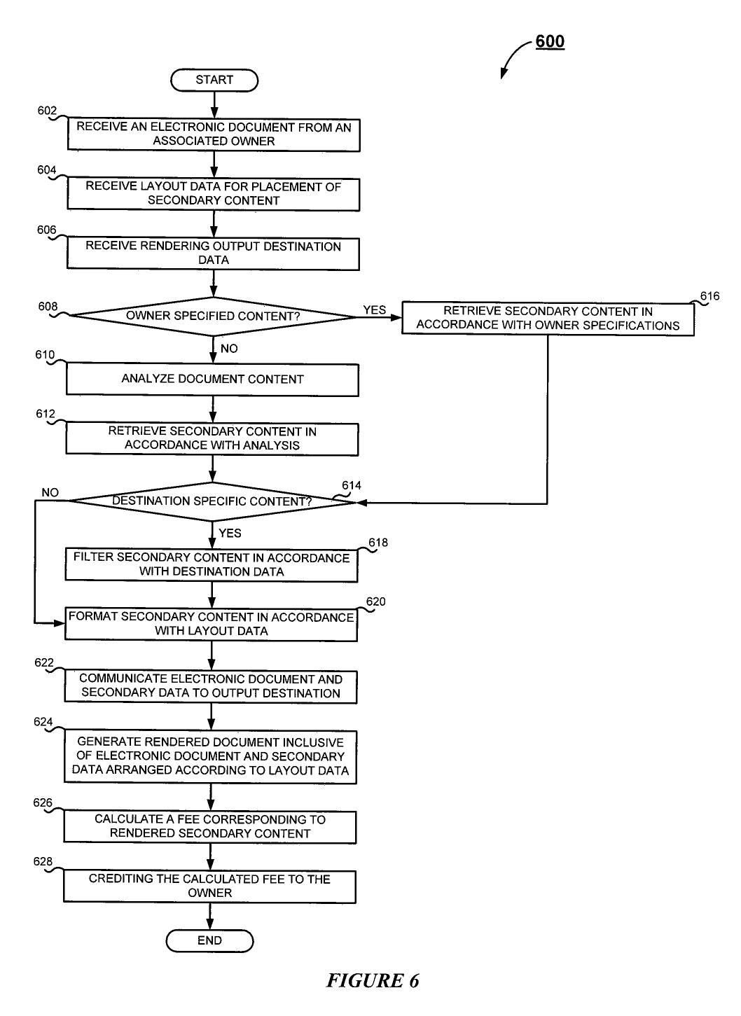

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for selective incorporation of targeted content in remotely rendered documents in accordance with one embodiment of the subject application. For example purposes only, reference is made hereinafter to the owner being associated with the first document processing device 104 and the destination data corresponds to the second document processing device 122. Beginning at step 502, an electronic document is first received from an owner at the first document processing device 104 corresponding to a document to be output by the first document processing device 104 to a selected location.

At step 504, the controller 108 or other suitable component associated with the first document processing device 104 receives layout data corresponding to the size and/or the position available for placement of the secondary content in connection with the rendering of the electronic document by the second document processing device 122. The first document processing device 104 then receives destination data corresponding to an output destination, e.g. the second document processing device 122, for a rendering of the electronic document at step 506. It will be appreciated by those skilled in the art that the destination data is capable of including, for example and without limitation, an electronic mail address, a facsimile number, an IP address, a network URL, or the like. At step 508, the secondary content is then retrieved in accordance with the received destination data.

The retrieved secondary content is then formatted based upon the received layout data by the controller 108 or other suitable component associated with the first document processing device 104 at step 510. At step 512, the received electronic document and the retrieved secondary content are communicated to the output destination in accordance with the received destination data. The output destination, e.g. the second document processing device 122, then generates the rendered document at step 514 inclusive of the received electronic document and retrieved secondary content mutually arranged in accordance with the layout data.

Referring now to FIG. 6, there is shown a flowchart 600 illustrating a method for selective incorporation of targeted content in remotely rendered documents in accordance with one embodiment of the subject application. The method of FIG. 6 begins at step 602, whereupon an electronic document is received by the first document processing device 104 from an owner. According to one embodiment of the subject application, the electronic document is representative of, for example and without limitation, a scanned hard copy document, a photograph, a map, an advertisement, a MICROSOFT OFFICE document, a web-based document, or the like. Those skilled in the art will appreciate that the owner is capable of communicating the electronic document to a document processing device 104 or 122 via the kiosk 114 or 132, via an electronic mail communication, uploaded to a shared network resource (not shown), stored on the server 140, generated via an operation of the document processing device 104 or 122 or the like. For example purposes only, reference is made hereinafter to an owner accessing the first document processing device 104 via the kiosk 114 or associated user interface 106 for communication of the electronic document to a remote location, e.g. the second document processing device 122.

At step 604, the controller 108 or other suitable component associated with the first document processing device 104 receives layout data corresponding to the position, size, and/or format of secondary content from the associated owner. In accordance with one embodiment of the subject application, the owner is prompted to select the desired layout of the secondary content via a graphical user interface displayed via the display 116, the user interface 106, a remote device (not shown), or the like. Suitable secondary content includes, for example and without limitation, a preselected advertisement, an automatically generated advertisement, an image, a text box, a logo, a map, a product description, or the like. In accordance with another embodiment of the subject application, the placement and the shape of the secondary content is capable of being arbitrarily determined by the controller 108 or other suitable component associated with the document processing device 104, selected by the owner, set by a provider of document processing services, or the like.

Rendering output destination data is then received at step 606 from the owner of the electronic document by the controller 108 or other suitable component associated with the document processing device 104. Those skilled in the art will appreciate that the destination data corresponds to the device that the owner selects to output the rendered document, e.g. the second document processing device 122. In accordance with one example embodiment of the subject application, the owner inputs the destination data via the user interface 106 associated with the first document processing device 104 or the user interface components 116 and 118 associated with the kiosk 114. It will be appreciated by those skilled in the art that the subject application is also capable of enabling the owner to communicate with the server 140 via the user interface 106 or kiosk 114 to retrieve recipient information corresponding to a desired destination, e.g. an electronic mail address, a facsimile number, an IP address, a network URL, or the like.

A determination is then made at step 608 whether owner specified content has been selected for incorporation as the secondary content data. That is, the controller 108 or other suitable component associated with the document processing device 104 determines whether or not the owner has specifically identified secondary content, such as an advertisement, map, or the like, for incorporation in a rendered document. Upon a positive determination at step 608, operations proceed to step 616, whereupon the specified secondary content is suitably retrieved, e.g. from the database 142 of the server 140, from a web site, from a portable storage medium, from a second document scanned by the owner, or the like. Flow then progresses to step 614, discussed in greater detail below.

Upon a negative determination at step 608, i.e. no owner specified content is available, flow proceeds to step 610, whereupon the content of the electronic document is analyzed so as to determine appropriate secondary content. Suitable types of analysis include, for example and without limitation, keyword analysis, word frequency and font size, and the like. At step 612, secondary content is then retrieved by the controller 108 or other suitable component associated with the document processing device 104 in accordance with the results of the content analysis of the electronic document. In accordance with one embodiment of the subject application, the secondary content is retrieved from the server 140 having a database 142 inclusive of secondary content applicable to a myriad of contexts. Preferably, such a database 142 includes advertisements or the like provided by third party advertisers to offset the costs associated with performing document processing operations via the network 102. According to another embodiment of the subject application, the controller 108 or other suitable component associated with the document processing device 104 performs an Internet search based upon the analysis so as to ascertain suitable secondary content and retrieves the same.

Operations then progress to step 614, whereupon a determination is made whether destination specific content is required. That is, whether or not the secondary data is to be filtered so as to limit the content based upon the destination data. Upon a determination at step 614 that the secondary content is destination specific, flow proceeds to step 618, whereupon the secondary content is geographically filtered with respect to the destination, e.g. the physical location of the second document processing device 104. After filtration, or upon a determination at step 614 that filtering is not required, flow proceeds to step 620. At step 620, the controller 108 or other suitable component associated with the document processing device 104 formats the retrieved secondary content based upon the layout data. Thereafter, the electronic document and the formatted secondary content are communicated to the destination over the computer network 102 according to the destination data at step 622. That is, the first document processing device 104 transmits the electronic document and formatted secondary content to the second document processing device 122 via the computer network 102.

Following receipt of the electronic document and secondary content, the second document processing device 122 generates a rendered document inclusive of the electronic document and the secondary content data based upon the retrieved layout data at step 624. It will be appreciated by those skilled in the art that the second document processing device 122 thus renders a document corresponding to the received electronic document with the secondary content incorporated in accordance with the position and shape designated by the layout data. At step 626, the controller 108 or other suitable component associated with the document processing device 104 calculates a fee corresponding to the rendered secondary content. The fee is then credited to the owner of the electronic document at step 628. For example, when the secondary content corresponds to an advertisement supplied by a third party, the owner of the document is credited a predetermined amount of the fee paid by the third party to include the advertisement on the rendered document.

It will be appreciated by those skilled in the art that the first document processing device 104 is capable of communicating the data corresponding to the electronic document and secondary content to the server 140 for fee calculations. In such an embodiment, the server 140 determines the appropriate fee to credit and stores such data in an account on the database 142 associated with the owner. According to a further embodiment of the subject application, the owner is charged for the transmission of the electronic document to the destination, with a portion of the costs of the transmission offset due to the inclusion of an advertisement. In accordance with another embodiment of the subject application, a third party associated with the secondary content is charged for the cost of the document processing operation, and the owner is credited with a portion of such charge for allowing the inclusion of such secondary content in the rendered document.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for selective incorporation of targeted content in remotely rendered documents comprising:
means adapted for receiving an electronic document from an owner thereof;
means adapted for receiving layout data corresponding to at least one of a size and position available for placement of secondary content in connection with a rendering of the electronic document;
means adapted for receiving destination data corresponding to at least one output destination for a rendering of the electronic document;
retrieval means adapted for retrieving secondary content in accordance with received destination data;
means adapted for formatting retrieved secondary content in accordance with received layout data; and
means adapted for communicating the received electronic document and retrieved secondary content to at least one output destination in accordance with received destination data so as to generate a rendered document at the at least one output destination, wherein the rendered document includes the received electronic document and retrieved secondary content mutually arranged in accordance with the layout data.

2. The system of claim 1, further comprising:
fee calculation means adapted for calculating a fee corresponding to rendered secondary content; and
means adapted for crediting a fee calculated by the fee calculation means to the owner.

3. The system of claim 2, wherein the fee calculation means further includes means adapted for calculating the fee in accordance with received layout data.

4. The system of claim 1, wherein the secondary content includes data corresponding to an advertisement for at least one of goods or services available at the at least one output destination.

5. The system of claim 4, further comprising analyzing means adapted for analyzing content of the electronic document, and wherein the retrieval means further includes means adapted for retrieving secondary content in accordance with an analysis of content by the analyzing means.

6. A method for selective incorporation of targeted content in remotely rendered documents comprising the steps of:
receiving an electronic document from an owner thereof;
receiving layout data corresponding to at least one of a size and position available for placement of secondary content in connection with a rendering of the electronic document;
receiving destination data corresponding to at least one output destination for a rendering of the electronic document;
retrieving secondary content in accordance with received destination data;
formatting retrieved secondary content in accordance with received layout data; and
communicating the received electronic document and retrieved secondary content to at least one output destination in accordance with received destination data so as to generate a rendered document at the at least one output destination, wherein the rendered document includes the received electronic document and retrieved secondary content mutually arranged in accordance with the layout data.

7. The method of claim 6, further comprising the steps of:
calculating a fee corresponding to rendered secondary content; and
crediting a fee calculated by the fee calculation step to the owner.

8. The method of claim 7, wherein the step of calculating the fee includes calculating the fee in accordance with received layout data.

9. The method of claim 6, wherein the secondary content includes data corresponding to an advertisement for at least one of goods or services available at the at least one output destination.

10. The method of claim 9, further comprising the step of analyzing content of the electronic document, and wherein the secondary content is retrieved in accordance with an analysis of content by the analyzing step.
